(19) United States
(12) Patent Application Publication
(10) Pub. No.: US 2010/0022209 A1
(43) Pub. Date: Jan. 28, 2010

(54) METHOD AND APPARATUS FOR REDUCING PEAK CURRENT VARIATION IN A RADIO

(75) Inventors: Chin Wun Ng, Ipoh (MY); Chen Kok Yeoh, Bukit Mertajam (MY)

Correspondence Address: MOTOROLA, INC, 1303 EAST ALGONQUIN ROAD, IL01/3RD, SCHAUMBURG, IL, 60196, US

(73) Assignee: Motorola, Inc, Schaumburg, IL (US)

(21) Appl. No.: 12/179,895

(22) Filed: Jul. 25, 2008

(51) Int. Cl. H04B 1/04

(52) U.S. Cl. 455/127.2

(57) ABSTRACT

The application discloses a method and apparatus for reducing peak current variation in a radio. The method includes monitoring (202) output power of a power amplifier (106) and determining (204) that the output power of the power amplifier is above a predefined threshold. The method then includes controlling (206) input power of the power amplifier (106) so that the output power is reduced below the predefined threshold. The method further includes isolating the power amplifier (106) from receiving signals reflected from an antenna (112) such that the output power is maintained below the predefined threshold. The method then includes effecting (208) amplification of a radio frequency signal at the maintained output power in the linear region of operation such that the radio frequency signal is amplified with reduced peak current variation.

### FIELD OF THE DISCLOSURE

The present disclosure relates generally to a radio system and more particularly to a method and apparatus for reducing peak current variation in a radio system.

### BACKGROUND

Typically, a transmitter in a radio draws current from a battery while amplifying and transmitting RF signals. Under certain operating conditions, the transmitter may draw higher current causing increased power dissipation to internal transmitter components. Excessive increases in power dissipation can cause damage to the radio and thus power dissipation and current drain are major concerns when designing battery powered radio systems.

When operating battery powered radio products under adverse environmental conditions, the ability to maintain power dissipation and peak current drain levels becomes particularly important. For example, manufacturers of electrical and mechanical equipment for use in and around potentially explosive atmospheres may need to comply with the Atmospheres Explosibles (ATEX) Directive. The ATEX Directive is far reaching in scope and includes an extensive set of compliance requirements. Products are categorized by the level of protection required in order to prevent them from becoming a potential source of ignition of an explosive atmosphere. Thus, controlling peak current variation is an important design parameter in the development of battery operated radio systems, whether for ATEX compliant radio systems or other radio systems operating within adverse environments.

In general, a radio transmitter operates in a linear region to reduce peak current variation in the radio. However, load variations within the radio may cause the transmitter to move to a non-linear region which may result in large peak current variation. One example of load variation may be due to signals reflected from the antenna coupled to the power amplifier. Also, in some instances, there may be unpredictable external environmental conditions that may move the transmitter to an early stage of the non-linear region which is unknown to the radio and may result in a large peak current variation in the transmitter. Public safety radios and radios requiring ATEX compliance are examples of radio systems that may face unpredictable operating conditions.

Accordingly, there exists a need for reducing peak current variation in a radio, such a reduction would be particularly desirable in an ATEX radio system or other public safety radio system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an apparatus for reducing peak current variation in a radio, in accordance with some embodiments.

FIG. 2 is a flowchart of a method for reducing peak current variation in a radio, in accordance with some embodiments.

FIG. 3 is a detailed flowchart of a method for reducing peak current variation in a radio, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure is directed towards a method for reducing peak current variation in a radio. The method includes monitoring output power of a power amplifier and determining that the output power of the power amplifier is above a predefined threshold. The method then includes controlling input power of the power amplifier and isolating the power amplifier from receiving signals reflected from an antenna such that the output power is maintained below the predefined threshold to maintain the power amplifier in a linear region of operation. The method further includes effecting amplification of a radio frequency signal at the maintained output power in the linear region of operation such that the radio frequency signal is amplified with reduced peak current variation.

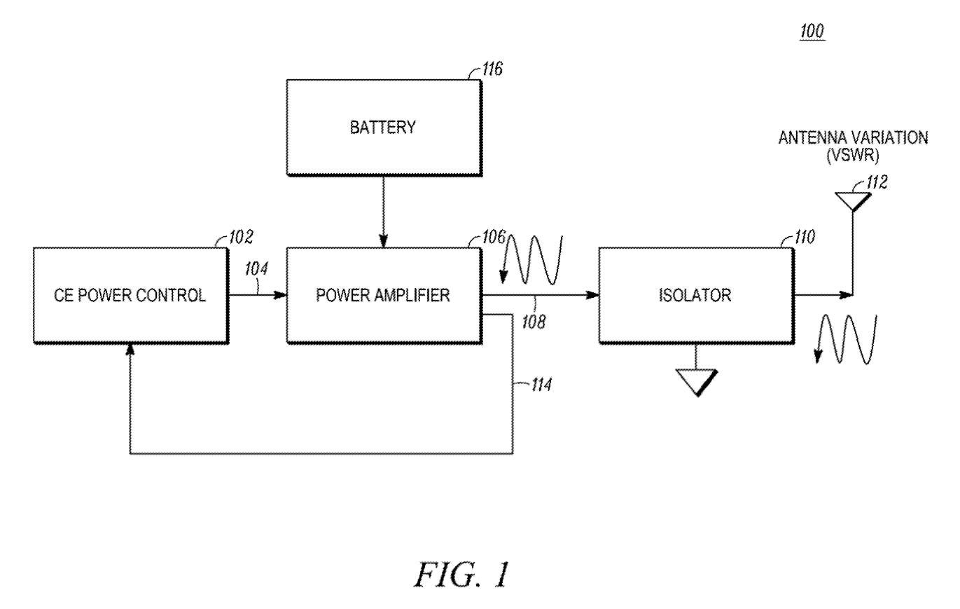

FIG. 1 is a block diagram illustrating exemplary internal components of an apparatus 100 for reducing peak current variation in a radio, in accordance with some embodiments of the invention. The radio may be a battery powered portable public safety radio that operates in a terrestrial trunked radio (TETRA) system or any other similar system which requires the radio to be operated in a linear region with limited peak current variation. TETRA system is a digital system that is based on a combination of frequency division multiple access (FDMA) and time division multiple access (TDMA). In general, TETRA is a combined group of radio communications, mobile telephony and mobile data communications. TETRA system has a multi-mode capability and provides integrated digital trunked and direct modes of operation into a single terminal radio. In accordance with the embodiment, the radio in TETRA systems may operate in the 380-400 MHz and 410-430 MHz frequency bands. Also, TETRA systems may provide services such as dispatch control over communication, semi duplex group calls, individual calls, full duplex call inside the system and towards external systems, broadcast calls etc.

In accordance with the embodiment, the radio may be a wireless device, a mobile station, a battery operated portable two-way hand-held radio, a mobile radio, or any similar device that can transmit and receive signals. The radio may be configured to operate according to any of a number of different 2G, 3G and 4G wireless communication technologies.

In accordance with the embodiment, the radio employs digital modulation for modulating and transmitting radio frequency (RF) signals. Since the radio performs digital modulation, it is required to operate the radio in a linear region to prevent splatter to an adjacent channel. To maintain the radio in such a linear region, the apparatus 100 in the radio employs the exemplary components as illustrated in FIG. 1 to reduce the peak current variation in the radio. The exemplary components include a battery 116, a circular eliminator (CE) power control unit 102, a power amplifier (PA) 106, an isolator 110, a Cartesian feedback loop 114, and an antenna 112.

In accordance with the embodiment, the power amplifier (PA) 106 amplifies radio frequency (RF) signals and transmits the amplified RF signals via the antenna 112. For amplifying such RF signals, the power amplifier 106 draws current from the battery 116 connected to the power amplifier 106.

The battery 116 may be any kind of voltage source that supplies current to the power amplifier 106 which is used for amplifying the RF signals. However, due to ATEX concerns, there is a limitation of a maximum peak current that can be provided by the battery 116. For example, supplying large amount of current to the power amplifier 106 may increase power dissipation of internal components of the power amplifier 106, that in-turn may damage the radio. Thus, the battery 116 is designed to supply current below a predefined threshold level to avoid large amounts of current variation in the radio.

In accordance with the embodiment, the circular eliminator (CE) power control unit 102 is coupled to the power amplifier 106 for controlling output power and phase of the power amplifier 106 when there is change in impedance at the antenna 112. The CE power control unit 102 includes CE algorithm for correcting the output power of the power amplifier 106 when the power amplifier 106 starts to operate at a non-linear region. In one embodiment, the power amplifier 106 may begin shifting to the non-linear region in response to changes in temperature, antenna load, battery voltage, or other changes in the radio.

In accordance with the embodiment, the CE power control unit 102 monitors the output power of the power amplifier 106 and determines whether the output power of the power amplifier 106 is above a predefined threshold. If the output power is above the predefined threshold, the CE power control unit 102 controls input power of the power amplifier 106 so that the output power is reduced below the predefined threshold and the power amplifier 106 is maintained in the linear region/zone. In another embodiment, the CE power control unit 102 determines the change in characteristics of the power amplifier 106, for example, the power amplifier 106 moving to the non-linear region, and reacts immediately during transmission periods.

In accordance with the embodiment, the CE power control unit 102 is programmed with CE thresholds that are used as guidelines to control the output power of the power amplifier 106. The CE thresholds include: a) Noise, b) SMS, and c) ASMSP, which are normalized signals of TETRA systems. Other CE thresholds can be established for non TETRA systems. The noise threshold indicates that the radio is reaching a state that is before reaching a saturated region where the radio may be damaged or crashed. The noise threshold also indicates the radio to reduce the power immediately when the output power is above the noise threshold. The SMS threshold indicates that the radio is in a non-linearity region of operation and also indicates to reduce output power of the power amplifier. The ASMSP threshold indicates that the radio has moved back from the state that is before reaching the saturated region and operating in the linear region. The ASMSP is average SMS that protects the radio from extreme non-reversible power reduction by indicating that the radio needs to increase the output power of the power amplifier.

The CE power control unit 102 may react according to the following conditions:

a) If a normalized NOISE power is above the NOISE threshold, the CE power control unit 102 reduces the output power of the power amplifier 106.
b) If a normalized SMS power is above the SMS threshold, the CE power control unit 102 reduces the output power of the power amplifier 106.
c) If a normalized ASMSP power is below the ASMSP threshold then the CE power control unit 102 increases the output power of the power amplifier 106.
d) Otherwise, the CE power control unit 102 may adjust the Cartesian feedback loop 114 to maintain the output power below the predefined threshold.

However, as mentioned above, the CE power control unit 102 may react according to the changes at the antenna load. The changes at the antenna load may in-turn change the output power of the power amplifier 106 which is unpredictable and may depend on the changes at that condition. So there are chances that the power amplifier 106 may be working at an early stage of the non-linear region which is unpredictable by the CE power control unit 102. Moreover, at this condition, the normalized NOISE or SMS is below the CE threshold when there is a load change at the antenna and the CE power control unit 102 will maintain the output power by adjusting the Cartesian feedback loop 114. As a result, the power amplifier 106 may drain more current in order to maintain the output power due to load changes. Thus, the isolator 110 is introduced as one of the exemplary components of the radio to maintain constant load at the output of the power amplifier 106.

In accordance with an embodiment, the isolator 110 is coupled to an output of the power amplifier 106 to isolate the power amplifier 106 from change in impedance of an antenna switch and/or antenna 112. The function of the isolator 110 is to provide constant impedance, for example 50 ohms reference, to the power amplifier 106. Also, the use of the CE eliminates the need for amplitude training systems, coupled to the isolator, which draw high power when determining peek current variation. The CE can also be used within radio designs employing amplitude training systems thereby providing backward compatibility to existing designs. The isolator in such designs is simply decoupled from the amplitude training systems thereby avoiding the high current drain that these systems draw during peak current determination.

In accordance with the embodiment, the isolator 110 receives amplified RF signals from the power amplifier and sends such amplified RF signals to the antenna 112. However, the antenna 112 may reflect a portion of the RF signals and may send such reflected signals back to the isolator 110 due to change in impedance at the antenna 112. The reflected signals may vary the load at the output of the power amplifier 106, which in-turn moves the power amplifier 106 to the non-linear region. Moving the power amplifier 106 to the non-linear region may result in peak current variation and may require large amount of current from the battery 116 to support the peak current variation in the power amplifier 106. However, the battery 116 may not support such peak current variation in radio due to limitations of ATEX concerns or other public safety requirements. Thus, the reflected signals need to be isolated from reaching the power amplifier 106.

In accordance with the embodiment, the isolator 110 at the output of the power amplifier 106 receives such reflected signals from the antenna 112 and isolates the RF signals from the power amplifier 106. The isolator 110 isolates the reflected signals by absorbing or suppressing the signals within the isolator 110. In another embodiment, the isolator 110 may send the reflected signals in a path that is unconnected to the power amplifier 106. Thus, isolating the reflected signals, from the output of the power amplifier 106, may maintain the power amplifier 106 in the linear region, which in turn-reduces the peak current variation or current drain behavior in the radio.

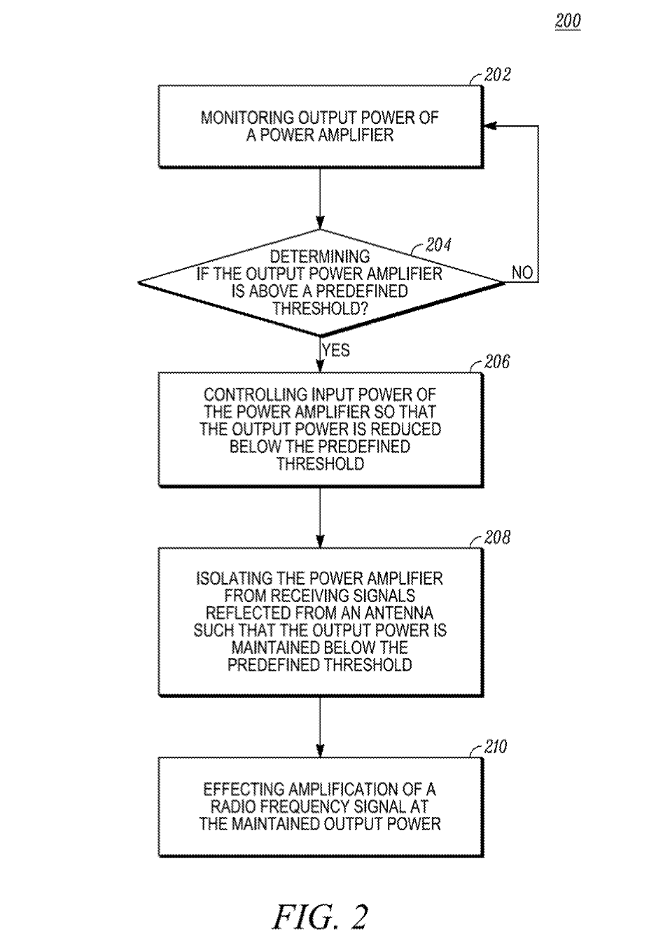

FIG. 2 is a flowchart of a method for reducing peak current variation in a radio, in accordance with some embodiments. Please note that the method 200 is described from the perspective of an apparatus 100 in the radio shown in FIG. 1. Referring to FIG. 2, the method begins with a step of monitoring 202 output power of a power amplifier. In one embodiment, the Cartesian feedback loop, coupled between the output of the power amplifier and an input of the CE power control unit, is employed for monitoring the output power of the power amplifier. The method then continues with a step of determining 204 that if the output power of the power amplifier is above a predefined threshold. This is accomplished by, the CE power control unit receiving the output power of the power amplifier via the Cartesian feedback loop and then comparing the received output power with the predefined threshold so as to determine whether the output power is above the predefined threshold.

When the power has been determined to be above the predefined threshold at step 204, the method then continues with a step of controlling 206 input power of the power amplifier so that the output power is reduced below the predefined threshold. In one embodiment, the CE power control unit controls the input power of the power amplifier by reducing the input power supplied to the power amplifier when the received output power is above the predefined threshold.

The method then continues with a step of isolating 208 the power amplifier from receiving signals reflected from an antenna such that the output power is maintained below the predefined threshold. The isolator coupled to the power amplifier absorbs the signals reflected from the antenna so that the power amplifier is prevented from receiving the signals. The method then continues with a step of effecting amplification 210 of a radio frequency (RF) signal at the maintained output power such that the radio frequency signal is amplified with reduced peak current variation. Effecting amplification of the RF signal includes amplifying the RF signal without receiving additional current from the battery, and also maintaining the characteristics of the power amplifier within a linear region. The amplified signals are then transmitted via the antenna coupled to the output of the isolator.

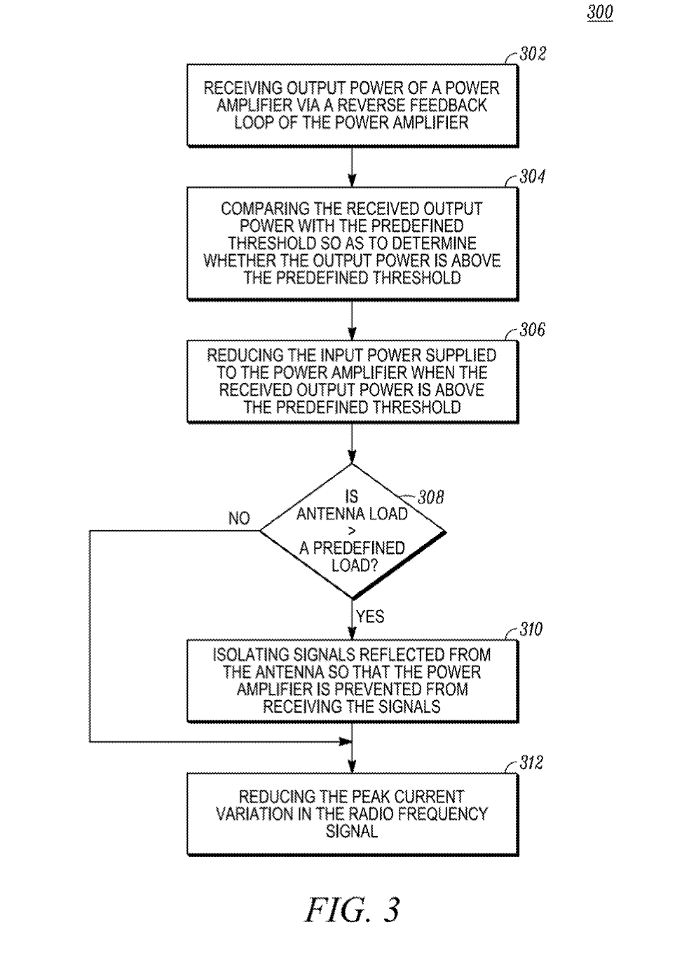

FIG. 3 is a detailed flow chart of the method for reducing peak current variation in a radio in accordance with some embodiments. FIG. 3 elaborates the steps described in FIG. 2. Referring to FIG. 3, the method 300 starts with a step of receiving 302 output power of the power amplifier via a reverse feedback loop of the power amplifier. The reverse feedback loop is connected between the output of the power amplifier and an input of the CE power control unit. In one embodiment, the reverse feedback loop may be a Cartesian feedback loop. The method then continues with a step of comparing 304 the received output power with the predefined threshold so as to determine whether the output power is above the predefined threshold. The method then continues with a step of reducing 306 the input power supplied to the power amplifier when the received output power is above the predefined threshold. The method then continues with a step of determining 308 whether the antenna load is below a predefined load. If the antenna load is below the predefined load, the method moves to a step of reducing 312 the peak current variation in the radio frequency signal.

On the other hand, if the antenna load is above the predefined load, the method moves to a step of isolating 310 signals reflected from the antenna so that the power amplifier is prevented from receiving the signals. The method then continues with a step of reducing 312 the peak current variation in the radio frequency signals while amplifying the RF signals in the power amplifier. Thus, the method reduces the peak current variation in a radio by maintaining the output power of the power amplifier below the predefined threshold.

Thus, the method employs CE algorithm and Isolator that resolves the high current drain issue in the power amplifier and also provides a consistent load to the power amplifier. It also minimizes the load variation at the output of the amplifier that in-turn reduces large amounts of current variation in the power amplifier even while the power amplifier is operating at extreme temperature. Also, the method has the advantage of avoiding the use of amplitude training systems that drain high current in the process of determining the current variation in the power amplifier.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for reducing peak current variation in a radio, the method comprising:
monitoring output power of a power amplifier;
determining that the output power of the power amplifier is above a predefined threshold, the predefined threshold indicating a movement of the power amplifier towards a non-linear region of operation;
controlling input power of the power amplifier and isolating the power amplifier from receiving signals reflected from an antenna such that the output power is maintained below the predefined threshold to maintain the power amplifier in a linear region of operation; and
effecting amplification of a radio frequency signal at the maintained output power in the linear region of operation such that the radio frequency signal is amplified with reduced peak current variation.

2. The method of claim 1, wherein determining that the output power of the power amplifier is above the predefined threshold comprises:
receiving the output power of the power amplifier via a reverse feedback loop of the power amplifier; and
comparing the received output power with the predefined threshold so as to determine whether the output power is above the predefined threshold.

3. The method of claim 2, wherein controlling the input power of the power amplifier comprises reducing the input power supplied to the power amplifier when the received output power is above the predefined threshold.

4. The method of claim 3, wherein the input power of the power amplifier is controlled by a circular eliminator (CE).

5. The method of claim 1, wherein isolating the power amplifier from the signals reflected from the antenna comprises absorbing the signals reflected from the antenna so that the power amplifier is prevented from receiving the signals, wherein the signals are absorbed by passing the signals in a path unconnected to the power amplifier.

6. The method of claim 5, wherein the signals reflected from the antenna are due to change in impedance associated with the antenna.

7. The method of claim 1, wherein the power amplifier is isolated, from receiving signals reflected from an antenna, by an isolator coupled to an output of the power amplifier.

8. The method of claim 1, wherein effecting amplification of a radio frequency (RF) signal comprises amplifying the radio frequency signal without receiving additional current from a battery.

9. The method of claim 1, wherein the radio is a portable battery operated radio.

10. The method of claim 1, wherein the radio is a battery powered portable two-way radio.

11. The method of claim 1, wherein the radio operates in a terrestrial radio access network (TETRA) system.

12. An apparatus for reducing peak current variation in a radio, the apparatus comprising:
a circular eliminator for monitoring output power of a power amplifier, and controlling input power of the power amplifier when the monitored output power is above a predefined threshold, wherein the input power is controlled to reduce the output power below the predefined threshold;
an isolator for isolating the power amplifier from signals reflected from an antenna such that the output power is maintained below the predefined threshold, wherein the isolator is coupled to an amplitude training system for determining the peak current variation in the power amplifier; and
the power amplifier coupled to the circular eliminator and the isolator for amplifying a radio frequency signal at the maintained output power so as to reduce the peak current variation in the radio frequency signal.

13. The apparatus of claim 12, wherein the isolator is coupled to the antenna for absorbing signals reflected from the antenna so that the power amplifier is prevented from receiving the signals reflected from the antenna.

14. The apparatus of claim 12, wherein the power amplifier is coupled to a Cartesian feedback system for providing the output power of the power amplifier to the circular eliminator.

15. The apparatus of claim 12, wherein the isolator is decoupled from the amplitude training system so as to reduce the output power of the power amplifier, wherein the isolator is decoupled from the amplitude training system by removing the amplitude training system out of the radio.

16. The apparatus of claim 12, wherein the radio comprises at least one of a portable two-way hand-held radio or a mobile radio.

17. The apparatus of claim 12, wherein the radio is an atmosphere explosibles (ATEX) compliant radio.
